(19) United States
(12) Patent Application Publication
(10) Pub. No.: US 2023/0280717 A1
(43) Pub. Date: Sep. 7, 2023

(54) HEAT-AWARE TOOLPATH GENERATION FOR 3D PRINTING OF PHYSICAL PARTS

(71) Applicant: Siemens Industry Software Inc., Plano, TX (US)

(72) Inventors: James Maynard, Chino Hills, CA (US); Timothy R. Fithian, Commerce Township, MI (US); Jeffrey A. Jaje, Macomb, MI (US)

(73) Assignee: Siemens Industry Software Inc., Plano, TX (US)

(21) Appl. No.: 18/001,379

(22) PCT Filed: Jun. 19, 2020
(86) PCT No.: PCT/US2020/038707

§ 371 Date: Dec. 9, 2022

(51) Int. Cl. G05B 19/4099; B33Y 50/00

(52) U.S. Cl. CPC G05B 19/4099; B33Y 50/00; G05B 2219/35134; G05B 2219/35167

(57) ABSTRACT

A computing system may include an access engine and a heat-aware toolpath engine. The access engine may be configured to access a slice of a 3-dimensional (3D) computer-aided design (CAD) object, wherein the 3D CAD object represents a physical part and wherein the slice represents a physical layer for 3D printing of the physical part. The heat-aware toolpath engine may be configured to generate a layer toolpath to control the 3D printing of the physical layer, including by partitioning the slice into zones and determining a zone order, based on a heat-aware criterion, for the layer toolpath to traverse for the 3D printing of the physical layer. The heat-aware toolpath engine may also be configured to provide the layer toolpath to support the 3D printing of the physical part.

### BACKGROUND

Computer systems can be used to create, use, and manage data for products and other items. Computer-aided technology (CAx) systems, for instance, may be used to aid in the design, analysis, simulation, or manufacture of products. Examples of CAx systems include computer-aided design (CAD) systems, computer-aided engineering (CAE) systems, visualization and computer-aided manufacturing (CAM) systems, product data management (PDM) systems, product lifecycle management (PLM) systems, and more. These CAx systems may include components (e.g., CAx applications) that facilitate design and simulated testing of product structures and product manufacturing.

### BRIEF DESCRIPTION OF THE DRAWINGS

Certain examples are described in the following detailed description and in reference to the drawings.

FIG. 1 shows an example of a computing system that supports generation of heat-aware toolpaths for 3-dimensional (3D) printing of physical parts.

FIG. 2 shows an example generation of a heat-aware toolpath for the 3D printing of a physical layer of a 3D part.

FIG. 3 shows an example application of a max-distance heat-aware criterion to generate a heat-aware toolpath for a 3D CAD object slice.

FIG. 4 shows an example application of a threshold-distance heat-aware criterion to generate a heat-aware toolpath for a 3D CAD object slice.

FIG. 5 shows an example application of a reverse heat-aware criterion to generate a heat-aware toolpath for a 3D CAD object slice.

FIG. 6 shows an example application of different heat-aware criteria for different portions of a 3D CAD object.

FIG. 7 shows an example of logic that a system may implement to support generation of heat-aware toolpaths for 3D printing of physical parts.

FIG. 8 shows an example of a computing system that supports generation of heat-aware toolpaths for 3D printing of physical parts.

### DETAILED DESCRIPTION

Additive manufacturing (sometimes referred to as 3-dimensional or 3D printing) may be performed via 3D printers that can construct objects on a layer-by-layer basis. Example forms of additive manufacturing include multi-axis 3D printing, in which 3D printers can adjust (e.g., tilt) an axis along which 3D construction is performed through material deposition, and laser powder bed fusion processes, in which a laser can be used as a power source to sinter/melt powdered material (e.g., metal powder) laid up on a powder bed or build platform. 3D printing may involve successively forming material in an incremental manner through use of 3D printing tools, such as through a material deposition head or an energy beam that is used to incrementally builds a 3D part in an ordered manner. As used herein, a toolpath may refer to any course, route, or pathing that is used by a 3D printer to construct any portion of a 3D part through additive manufacturing, whether as a path to successively deposit material for material deposition 3D printing technologies, as a path to guide a laser (or other energy emission) for energy application through LPBF-type 3D printing technologies, and more.

One challenge faced by modern 3D printing systems is handling heat generation caused by 3D printing processes. For instance, multi-axis 3D printing technologies may require sufficient heating of 3D printing materials into a malleable form (e.g., metal beads), and such heat may be amplified when using metal or other base plates that can accumulate, retain, and emit heat. Energy applications through LBPF lasers to sinter metal powder may likewise use and inject heat into a 3D printing system as part of the 3D printing process. Excess heat may adversely impact 3D part construction, for example by causing part warping in heat hotspots, inaccurate part constructions, and possibly part failures. Many current toolpath generation algorithms for 3D printing are optimized for 3D printing speed, without accounting for heat generation, and may thus be faced with increased part deformations, lower printing yields, or reduced printing efficiency. Simplistic solutions to pause a 3D printing processes during part construction may attempt to address heat-related part deformations, but at a cost of increased 3D part construction times and reduced efficiency.

The disclosure herein may provide systems, methods, devices, and logic for generation of heat-aware toolpaths for 3D printing of physical parts. As described in greater detail herein, various heat-aware toolpath features may support the design or reordering of 3D printing toolpaths to reduce the impact of heat-based deformations in 3D parts. Any toolpath generated through application of a heat-aware criterion (or heat-aware criteria) may be referred to herein as a heat-aware toolpath. Various heat-aware criteria are described herein, any of which may support generation of toolpaths (e.g., on a layer-by-layer basis) to control the 3D printing of 3D parts in a heat-aware manner.

In some instances, a given layer of a 3D part may be partitioned into smaller sections or zones, and a heat-aware layer toolpath for the given layer can be generated through application of any number of heat-aware criteria to determine a 3D printing order for the partitioned zones that is non-continuous or hops to different layer sections to reduce or avoid heat build-up. Such heat-aware generation of toolpaths for 3D printing processes may provide increased 3D printing effectiveness by reducing heat-based deformations (e.g., as compared to continuous, non-heat aware toolpaths) while also enhancing 3D printing efficiency by reducing 3D printing downtime in which a 3D printer is not actively constructing a 3D part (e.g., as compared simplistic 3D printing pause solutions).

These and other heat-aware toolpath features and technical benefits are described in greater detail herein.

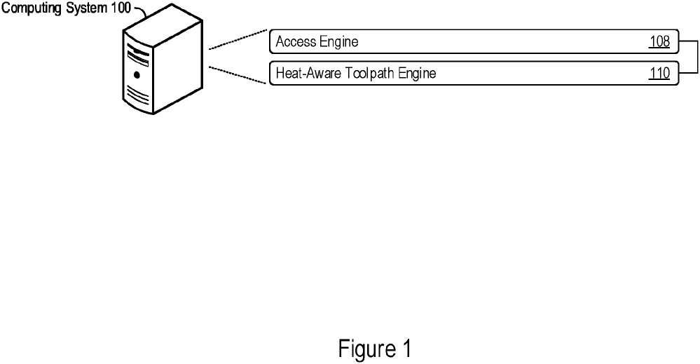

FIG. 1 shows an example of a computing system 100 that supports generation of heat-aware toolpaths for 3D printing of physical parts. The computing system 100 may take the form of a single or multiple computing devices such as application servers, compute nodes, desktop or laptop computers, smart phones or other mobile devices, tablet devices, embedded controllers, and more. In some implementations, the computing system 100 implements a CAx tool, application, or program to aid users in the design, analysis, simulation, or 3D manufacture of products, including heat-aware toolpath generation.

As an example implementation to support any combination of the heat-aware toolpath features described herein, the computing system 100 shown in FIG. 1 includes an access engine 108 and a heat-aware toolpath engine 110. The computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the access engine 108 may access a slice of a 3D CAD object. As used herein, a CAD object (including 3D CAD objects) may include any type of CAx object data relevant to part design, simulation, analysis, or manufacture. A CAD object may thus include 3D object designs, models, model slices, toolpaths, and more. The 3D CAD object accessed by the access engine 108 may represent a physical part and the slice may represent a physical layer for 3D printing of the physical part.

In operation, the heat-aware toolpath engine 110 may generate a layer toolpath to control the 3D printing of the physical layer, including by partitioning the slice into zones and determining a zone order, based on a heat-aware criterion, for the layer toolpath to traverse for the 3D printing of the physical layer. In operation, the heat-aware toolpath engine 110 may also provide the layer toolpath to support the 3D printing of the physical part.

These and other heat-aware toolpath features are described in greater detail next.

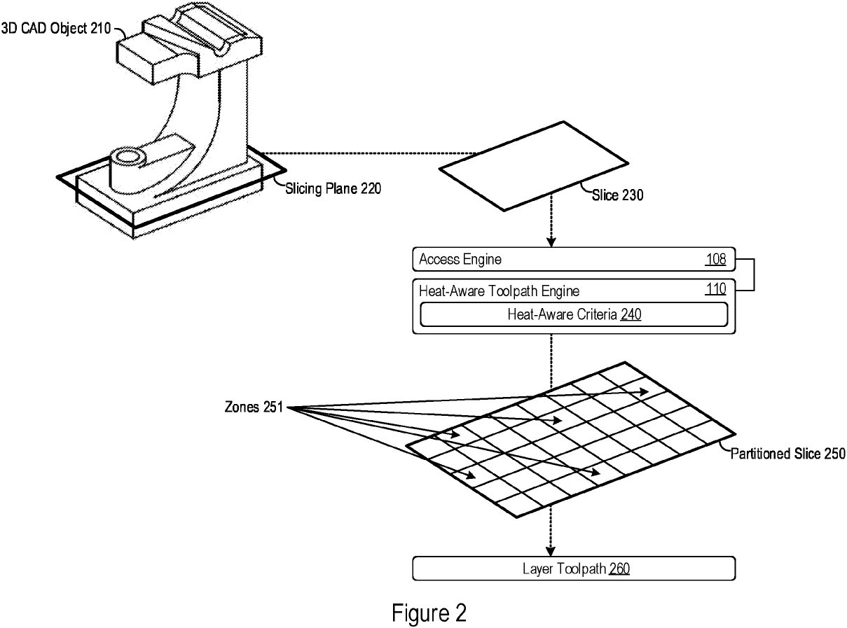

FIG. 2 shows an example generation of a heat-aware toolpath for the 3D printing of a physical layer of a 3D part. The example in FIG. 2 is illustrated via a computing system that implements an access engine 108 and a heat-aware toolpath engine 110. However, various other implementations are contemplated herein.

The access engine 108 may access any CAx data relevant to generation of heat-aware toolpaths. In some implementations, generation of heat-aware toolpaths is performed on a per-layer basis. In such examples, the access engine 108 may access any number of slices of a 3D CAD object to support heat-aware toolpath generation. In the example shown in FIG. 2, the access engine 108 accesses slices from a 3D CAD object 210, and the slices may be generated through a slicing plane 220 that intersects the CAD object 210 along any build-axis supported for the 3D printing of a physical part represented by the 3D CAD object 210. In some implementations, the access engine 108 may itself perform intersection operations on the 3D CAD object 210 to obtain accessed slices. In FIG. 2, the access engine 108 accesses a slice 230 of the 3D CAD object 210, and the slice 230 may represent a particular physical layer of a physical part represented by the 3D CAD object 210.

The heat-aware toolpath engine 110 may generate heat-aware toolpaths to control the 3D printing of physical layers represented by accessed slices of 3D CAD objects, including by applying heat-aware criteria 240. The heat-aware criteria 240 may include any conditions, logic, algorithms, parameters, or other feature by which the heat-aware toolpath engine 110 generates a toolpath for the 3D printing of physical parts. The heat-aware criteria 240 may be configured by the heat-aware toolpath engine 110 to reduce heat accumulation during 3D printing of a physical layer, for example by splitting a layer toolpath route to construct a physical layer in a non-continuous manner, thus reducing heat build-up that may be otherwise present in continuous toolpaths optimized for shortest 3D printing routes. Various examples of various heat-aware criteria 240 that the heat-aware toolpath engine 110 may apply are described herein.

To generate heat-aware toolpaths, the heat-aware toolpath engine 110 may partition any portion of a 3D CAD object 210 into multiple zones. From the partitioned zones, the heat-aware toolpath engine 110 may determine an order by which to 3D print the zones, from which the heat-aware toolpath engine 110 may generate a toolpath to control the 3D printing of the CAD object portion. Such an order may be referred to herein as a zone order. As a continuing example used herein, the heat-aware toolpath engine 110 may partition an accessed slice of a 3D CAD object into zones, though any other CAD object portions are possible for heat-ware toolpath generation (e.g., toolpath generation for multiple slices, a selected portion of a given slice, specific user-selected volumes of a 3D CAD object, or any other given region of a 3D CAD object).

In the example shown in FIG. 2, the heat-aware toolpath engine 110 partitions the slice 230 into the partitioned slice 250. The partitioned slice 250 shown in FIG. 2 is partitioned in an 5 zone-by-8 zone manner to include a total of forty (40) zones. These forty (40) zones of the partitioned slice 250 are shown in FIG. 2 as the zones 251 (note that, for the sake of visual clarity, only some of the zones 251 are explicitly denoted by arrows in FIG. 2).

The heat-aware toolpath engine 110 may partition a slice (or any other CAD object portion) according to any number of partitioning parameters. The partitioning parameters by which the heat-aware toolpath engine 110 may divide a CAD object slice may be configurable, e.g., via user-settings or pre-programmed into the heat-aware toolpath engine 110. In some implementations, partition parameters are part of the heat-aware criteria 240 that the heat-aware toolpath engine 110 may apply for a given slice or CAD object portion. Examples of partition parameters include predetermined or threshold zone areas, perimeters, lengths and/or widths, zone shapes, or any other logic or parameters by which the heat-aware toolpath engine 110 divides 3D CAD object slices. In some implementations, the partition parameters may be flexible, in that partitioned zones of a given slice may have zone areas, lengths, widths, shapes, etc. that vary based on slice characteristics of the given slice (e.g., distance from a build plate or base, which may be measured as a z-value along the build axis, total area of the given slice, particular object features in the given slice, etc.).

The heat-aware toolpath engine 110 may generate a heat-aware toolpath from partitioned portions of a 3D CAD object. In doing so, the heat-aware toolpath engine 110 may determine a zone order for partitioned slices, and the zone order may, in effect, set a route for 3D printing that forms a heat-aware toolpath. Heat-aware criteria applied by the heat-aware toolpath engine 110 may control the zone order determination, and the heat-aware criteria may specify how the heat-aware toolpath engine 110 selects a starting zone for a heat-aware toolpath as well as subsequent zones in the zone order until each of the partitioned zones is accounted for in a generated zone order. To illustrate through the example shown in FIG. 2, the heat-aware toolpath engine 110 may apply the heat-aware criteria 240 to select an order that comprises each of the forty (40) zones 251 of the partitioned slice 250, and such an order may be used to form the layer toolpath 260 generated for 3D printing of a physical layer represented by the slice 230.

Object slices, slice partitioning, and zone order determinations need not be limited to 3D CAD model data. In some implementations, the access engine 108 may access a slice in the form of a previously generated toolpath or initial toolpath, which may include any conventionally generated toolpath that does not account for heat in its route (referred to herein as non-heat aware toolpaths). Examples of conventionally generated toolpaths include toolpaths optimized for 3D printing speed, such as a continuous line-scan material deposition route or laser hatch tracking generated by conventional 3D printing systems.

In tool path-based slice examples, the heat-aware toolpath engine 110 may partition the slice (in the form of an initial toolpath) by partitioning a non-heat-aware toolpath into different toolpath zones, and each toolpath zone may represent a specific (e.g., continuous) portion of the non-heat aware toolpath. In such implementations, the partitioned zones may be segments of a previously generated toolpath, and application of the heat-aware criteria 240 by the heat-aware toolpath engine 110 may generate a reordered (and non-continuous) toolpath that can reduce heat concentrations in 3D printing while also maintaining printing efficiency as compared to the non-heat-aware toolpath with inserted pause times to allow a 3D printing chamber to cool.

The heat-aware toolpath engine 110 may provide a generated layer toolpath to support the 3D printing of a physical part represented by a 3D CAD object. For instance, the heat-aware toolpath engine 110 may transmit the layer toolpath 260 as control data to a 3D printer, such that a deposition tool, laser or other energy source, or other 3D printing instrument traverses the layer toolpath 260 to physically manufacture the physical layer represented by the slice 230. In some implementations, the heat-aware toolpath engine 110 is implemented locally as part of a 3D printer itself, so heat-aware toolpath generation can occur on a same physical machine as the 3D printing of the physical part. In other implementations, the heat-aware toolpath engine 110 may be implemented remotely from a 3D printer (e.g., by a remote CAD system or in a cloud computing environment) and the layer toolpath 260 may be transmitted across a communication network to the 3D printer.

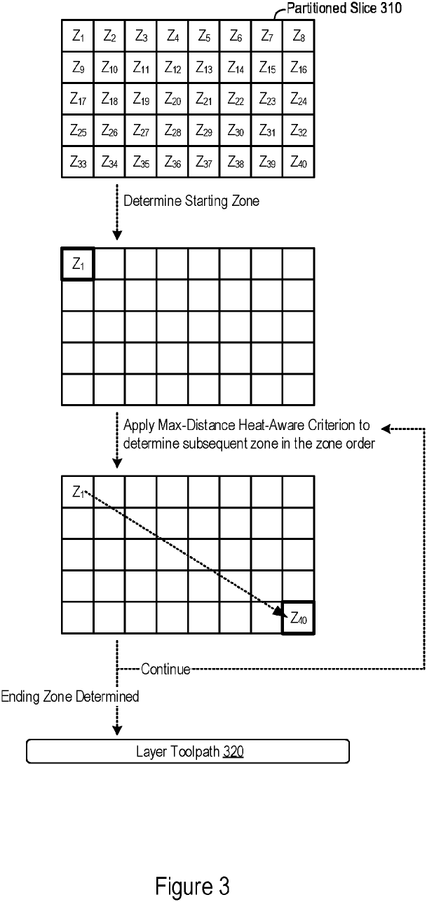

Accordingly, heat-aware toolpaths may be generated and physical construction of 3D parts may account for various applied heat-aware criteria applied to generate the heat-aware toolpaths. Some examples of heat-aware criteria that the heat-aware toolpath engine 110 may apply are presented next in connection with FIGS. 3-5.

FIG. 3 shows an example application of a max-distance heat-aware criterion to generate a heat-aware toolpath for a 3D CAD object slice. In the example of FIG. 3, application of a max-distance heat-aware criterion is described with reference to the heat-aware toolpath engine 110, through other implementations are possible and contemplated herein. A max-distance heat-aware criterion applied by the heat-aware toolpath engine 110 may specify selection of a subsequent zone in a zone order that is a maximum distance from a current zone. In that regard, the zone order determined by the heat-aware toolpath engine 110 may ensure that corresponding zones of a physical layer are 3D printed at a maximal distance from an immediately prior constructed zone, which may reduce (e.g., minimize) heat impact from the prior constructed zone.

To illustrate through FIG. 3, the heat-aware toolpath engine 110 may apply a max-distance heat-aware criterion for generation of a heat-aware toolpath for the partitioned slice 310. The partitioned slice 310 shown in FIG. 3 has forty (40) zones, and the zones of the partitioned slice 310 are labeled as Z₁-Z₄₀. A determined heat-aware zone order for the partitioned slice 310 may order some or all of the zones Z₁-Z₄₀ for 3D printing.

The heat-aware toolpath engine 110 may determine a starting zone for a zone order generated for the partitioned slice 310. The starting zone may refer to an initial zone of a partitioned 3D object portion at which 3D printing starts for a given heat-aware toolpath. In the example shown in FIG. 3, the heat-aware toolpath engine 110 selects zone Z₁ of the partitioned slice 310 as the starting zone for the zone order.

Determination of a starting zone for a given partitioned slice may be controlled by an applied max-distance heat-aware criterion (or any other heat-aware criterion). A heat-aware criterion applied by the heat-aware toolpath engine 110 may, for example, specify a random selection of a starting zone from the zones of a partitioned slice. As other examples, a heat-aware criterion may specify the starting zone as a predetermined zone (e.g., Z₁ or Z₄₀ of the partitioned slice 310) or as a zone located at particular slice location, whether relative (e.g., with a highest or lowest x-value coordinate in a partitioned slice) or absolute (e.g., at coordinates (0,0) of the partitioned slice using a coordinate system scaled specifically to the partitioned slice).

As yet another example, a heat-aware criterion may specify determination of a starting zone for a given slice based on an ending zone of a different slice, such as a different slice that is to be manufactured prior (e.g., immediately prior) to the given slice. Such a heat-aware criterion may specify determination of a starting zone in the zone order that is at least a threshold distance from an ending zone of a zone order determined for a different slice, wherein the different slice represents another physical layer that is to be manufactured prior to the physical layer represented by the given slice in the 3D printing of a physical part. In such starting zone determinations, the heat-aware criterion may reduce the heat impact caused from manufacture of a different physical layer.

The threshold distance set by the heat-aware criterion for determination of the starting zone may be a max distance or at least a predetermined distance, whether measured in zone distances (e.g. at least or physical distances (e.g., at least 15 centimeters away). Distances between zones of different slices at different heights in a physical part may be computed by the heat-aware toolpath engine 110 by projecting the ending zone of a different slice along a build axis unto a 2D plane that a given slice lies on, and then applying the threshold distance accordingly.

After determination of a starting zone for a zone order of a heat-aware toolpath, the heat-aware toolpath engine 110 may continually determine subsequent zones in the zone order until a threshold number of zones in the partitioned slice 310 are accounted for in the zone order (e.g., all zones). Any number of heat-aware criteria may be applied by the heat-aware toolpath engine 110 to determine subsequent zones in the zone order, such as the max-distance heat-aware criterion. To illustrate through FIG. 3, the heat-aware toolpath engine 110 may apply a max-distance heat-aware toolpath criterion to select a subsequent zone in the zone order that (immediately) follows the starting zone Z₁, which may be referred to a current zone in this iteration of a zone order determination process. In doing so, the heat-aware toolpath engine 110 may select an unscheduled zone in the partitioned slice 310 that is a maximum distance from the current zone, which is the starting zone Z₁ in this iteration. The unscheduled zones may refer to any zone in the partitioned slice 310 that has not yet been included in the zone order.

With Z₁ as the current zone, the heat-aware toolpath engine 110 may select a subsequent zone among the unscheduled zones Z₂-Z₄₀ that is a maximum distance from the current zone Z₁, thus selecting zone Z₄₀ as a subsequent zone in the zone order through application of a max-distance heat-aware criterion. In a consistent manner, the heat-aware toolpath engine 110 may iteratively apply a max-distance heat-aware criterion to determine a subsequent zone that follows a current zone in the zone order until each of the zones Z₁-Z₄₀ of the partitioned slice 310 has been scheduled in the zone order.

In some implementations the heat-aware toolpath engine 110 may apply a maximum distance function that accounts only for the current zone (e.g., a maximum distance from zone Z₁, then a maximum distance from zone Z₄₀, and so on). In some implementations, the heat-aware toolpath engine 110 may apply a maximum distance function that accounts for multiple prior zones in the zone order. In such implementations, a max-distance heat-aware criterion applied by the heat-aware toolpath engine 110 may determine a subsequent zone in the zone order through a function that maximizes the combined distance of (i) the subsequent zone and the current zone and (ii) the subsequent zone and a given zone scheduled in the zone order prior to the current zone.

To provide an illustrative example, the heat-aware toolpath engine 110 may perform multiple iterations of subsequent zone determinations to determine a zone order thus far of [Z₁, Z₄₀, Z₅, Z₃₃]. In this illustrative example, zone Z₃₃ may be referred to as the current zone for a next iteration of subsequent zone determination. In the next iteration, the max-distance heat-aware criterion may specify determination of subsequent zone that maximizes the sum of distances between (i) the subsequent zone and Z₃₃ (the current zone) and (ii) the subsequent zone and Z₅ (a given zone in the zone order scheduled prior to current zone, also referred to as a prior scheduled zone). In this illustrative example, the heat-aware toolpath engine 110 determines a max distance accounting for the current zone and one other prior scheduled zone. Alternatively, the max-distance heat-aware criterion may account for two, three, or more other prior scheduled zones in determination of a subsequent zone for a given iteration.

As yet another example, a max-distance heat-aware criterion applied by the heat-aware toolpath engine 110 may apply a weighted max distance function for distances between a current zone and prior scheduled zone(s). By doing so, the heat-aware toolpath engine 110 may, for instance, weight heat impact caused by a current zone to a greater degree in selecting a subsequent zone, but still account for prior scheduled zones to ensure proper pathing to reduce or minimize heat-based deformations during 3D printing. For instance, the max-distance heat-aware criterion may be expressed through a weighted function to determine a subsequent zone Z_{S} as a weighted function of distances to a current zone Z_{C} and prior scheduled zones Z_{C-1}, Z_{C-2}, etc., for example as:

$$M A X \left(0.8 ∗ d i s t \left({Z}_{S} , {Z}_{C}\right) + 0.15 ∗ d i s t \left({Z}_{S} , {Z}_{C - 1}\right) + 0.05 ∗ d i s t \left({Z}_{S} , {Z}_{C - 2}\right)\right)$$

In this example, the values 0.8, 0.15, and 0.05 serve as weight values for the current zone Z_{C}, prior scheduled zone Z_{C-1}, and prior scheduled zone Z_{C-2} respectively. The heat-aware toolpath engine 110 may determine the subsequent zone Z_{S} among remaining zones of the partitioned slice 310 that maximizes the value of the weighted distances of the current zone Z_{C} and prior scheduled zones Z_{C-1} and Z_{C-2}.

The heat-aware toolpath engine 110 may continue to apply a max-distance heat-aware criterion until each of the zones Z₁-Z₄₀ is scheduled in a zone order. The last zone in the zone order may be referred to as the ending zone, and upon determination of the ending zone, the heat-aware toolpath engine 110 may determine a zone order for the partitioned slice 310 that schedules all the zones Z₁-Z₄₀ for 3D printing of a physical layer represented by the partitioned slice 310. The heat-aware toolpath engine 110 may determine the ending zone when no other unscheduled zones in a partitioned CAD object portion remain.

The heat-aware toolpath engine 110 may use a determined zone order to generate a layer toolpath 320 for the partitioned slice 310. For zones of the partitioned slice 310 that may take the form of toolpath segments (e.g., partitioned from a non-heat-aware toolpath), the heat-aware toolpath engine 110 may generate the layer toolpath 320 by re-sequencing the toolpath segments in the determined zone order. For zones that may take the form of 2D or 3D CAD model portions, the heat-aware toolpath engine 110 may generate tool pathing for each zone (e.g., a starting point and traversal route within the zone). These zone-specific deposition routes or hatch tracking routes for energy application may be determined prior to zone order determination, and a default traversal route may be assigned for each zone (e.g., in a continuous scan line route). Generation of the layer toolpath 320 by the heat-aware toolpath engine 110 may then include ordering the zone-specific toolpaths in an order as specified by the determined zone order.

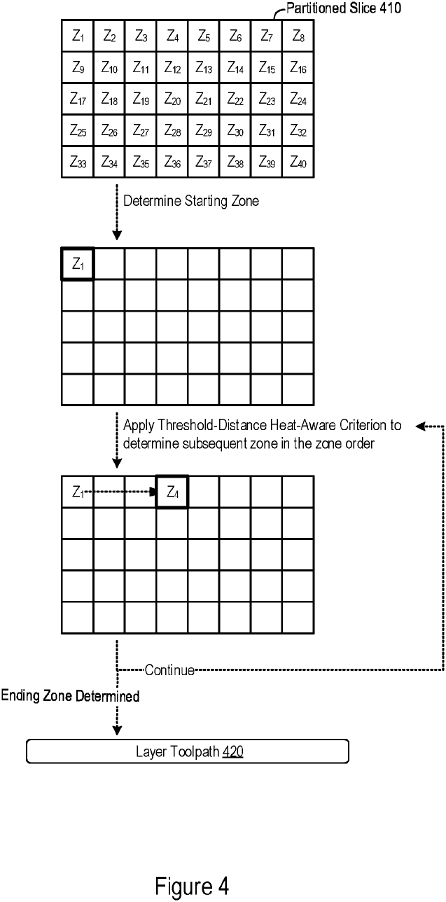

In any of the ways described above, the heat-aware toolpath engine 110 may generate heat-aware layer toolpaths for slices of 3D CAD objects using any number of max-distance heat-aware criteria. As another example, the heat-aware toolpath engine 110 may apply threshold-distance heat-aware criteria to generate heat-aware toolpaths, described next in connection with FIG. 4.

FIG. 4 shows an example application of a threshold-distance heat-aware criterion to generate a heat-aware toolpath for a 3D CAD object slice. The partitioned slice 410 of FIG. 4 has forty (40) zones, and the zones of the partitioned slice 410 are labeled in FIG. 4 as Z₁-Z₄₀. The heat-aware toolpath engine 110 may determine a starting zone of a zone order for the partitioned slice 410, doing so in any of the ways described herein. In that regard, a threshold-distance heat-aware criterion applied by the heat-aware toolpath engine 110 may specify criteria, logic, or parameters to determine the starting zone for the partitioned slice 410. In the example shown in FIG. 4, the heat-aware toolpath engine 110 selects zone Z₁ as the starting zone of a zone order for the partitioned slice 410.

The heat-aware toolpath engine 110 may apply a threshold-distance heat-aware criterion to iteratively determine subsequent zones in the zone order until each zone in the partitioned slice 410 (or selected portion thereof) is scheduled in the zone order. The threshold-distance heat-aware criterion may specify selection of a subsequent zone in the zone order that is a predetermined distance from a current zone. Predetermined distances may be specified on a zone-basis or physical measurement-basis. As illustrative examples, a threshold-distance heat-aware criterion may specify selection of a subsequent zone that is a distance of three (3) zones from a current zone or a distance of fifteen (15) centimeters from a current zone. In FIG. 4, the heat-aware toolpath engine 110 determines zone Z₄ as a subsequent zone for current zone Z₁ as zone Z₄ satisfies a threshold-distance heat-aware criterion of being a distance of three (3) zones from the current zone Z₁.

In some implementations, a threshold-distance heat-aware criterion may further specify selection criteria in case multiple unscheduled zones satisfy the threshold-distance heat-aware criterion. For a threshold-distance heat-aware criterion that specifies a threshold distance of three (3) zones, at least zones Z₄ and Z₂₅ satisfy the threshold distance requirement. Selection criteria may specify which among the multiple zones that satisfy the threshold-distance requirement to determine as the subsequent zone, e.g., through random selection, as the zone with a highest or lowest x-value coordinate, as the zone with the maximum distance from a prior scheduled zones, such as Z_{C-1}, or through any other configurable selection parameters that may be user-selected or pre-programmed.

In such a manner, the heat-aware toolpath engine 110 may iteratively apply a threshold-distance heat-aware criterion to determine a subsequent zone that follows a current zone in the zone order until each of the zones Z₁-Z₄₀ of the partitioned slice 410 has been scheduled in the zone order. The heat-aware toolpath engine 110 may then use the determined zone order to generate a layer toolpath 420 for the partitioned slice 410, doing so in any of the ways described herein.

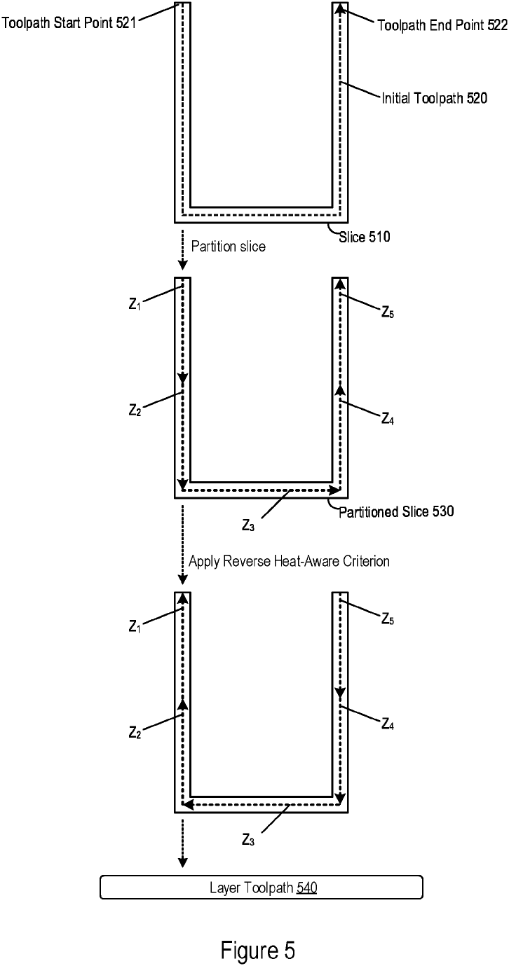

Yet another example of a heat-aware criterion that the heat-aware toolpath engine 110 may apply is described next in connection with FIG. 5.

FIG. 5 shows an example application of a reverse heat-aware criterion to generate a heat-aware toolpath for a 3D CAD object slice. Reverse heat-aware criteria may be specifically applied by the heat-aware toolpath engine 110 for slices that take the form of previously generated toolpaths, e.g., as non-heat-aware toolpaths generated using conventional pathing techniques. Such an example is shown in FIG. 5 in which a slice 510 (e.g., accessed by the access engine 108) takes the form of a previously-generated toolpath, labeled in FIG. 5 as the initial toolpath 520.

The initial toolpath 520 may be generated to optimize 3D printing efficiency, and may thus take the form of a continuous toolpath route that begins at the toolpath start point 521 in the slice 510 and ends at a toolpath end point 522. While the initial toolpath 520 may provide a degree of efficiency in manufacturing the physical layer represented by the slice 510, such a continuous path may cause part deformations from heat-related issues through heat injection in a continuous manner for a 3D part.

To support application of a reverse heat-aware criterion, the heat-aware toolpath engine 110 may partition the slice 510 by segmenting the initial toolpath 520 into different sections. Each of the toolpath segments of the initial toolpath 520 may be zones in a partitioned slice. As seen in FIG. 5, the heat-aware toolpath engine 110 may partition the slice 510 into the partitioned slice 530, which may comprise the five (5) different zones labeled as zones Z₁-Z₅ in FIG. 5. Each of the zones of the partitioned slice 530 may take the form of a zone-specific toolpath, as denoted by the arrows of each of zones Z₁-Z₅. Note that the heat-aware toolpath engine 110 may determine a zone order for the partitioned slice 530 according to any of the heat-aware criteria described herein, as any of heat-aware criteria may be applied to zones in the form of toolpath segments.

In applying a reverse heat-aware criterion, the heat-aware toolpath engine 110 may determine a zone order that is the same as a zone order of the initial toolpath 520. While the initial toolpath 520 itself may not have a specific zone order (as the initial toolpath 520 is not partitioned into zones), the zones of the partitioned slice 530 may be ordered by the heat-aware toolpath engine 110 to be the same as a zone order that would be used to effectuate the initial toolpath 520. In the example shown in FIG. 5, a reverse heat-aware criterion applied by the heat-aware toolpath engine 110 may specify setting a zone order of [Z₁, Z₂, Z₃, Z₄, Z₅], which would be an order that mirrors the ordering of the initial toolpath 520. However, in applying the reverse heat-aware criterion, the heat-aware toolpath engine 110 may reverse a starting point and ending point of some or all of the zone-specific toolpaths.

Such a reversal is illustrated in the example of 5, in which the heat-aware toolpath engine 110 may reverse the starting point and ending point of each of the zone-specific toolpaths of zones Z₁-Z₅. Thus, a heat-aware toolpath generated through application of the reverse heat-aware criterion may differ from the initial toolpath 520. In some implementations, a reverse heat-aware criterion applied by the heat-aware toolpath engine 110 may specify selection of a subsequent zone in the zone order that is adjacent to a current zone and generation of the layer toolpath for a partitioned slice may include reversing a starting point and ending point of a zone-specific toolpath for the subsequent zone. In such a manner, the heat-aware toolpath engine 110 may generate the layer toolpath 540 for the slice 510 through application of a reverse heat-aware criterion.

By reversing the starting points and end points of zone-specific toolpaths, application of reverse-heat criteria may ensure that the 3D printing route of a physical layer is non-continuous, allowing portions of the physical layer to cool and reduce heat impacts while nonetheless continuing to manufacture other portions of the physical layer. As such, the heat-aware toolpaths generated through application of heat-aware criteria may improve 3D part quality, maintain 3D printing efficiencies, or both.

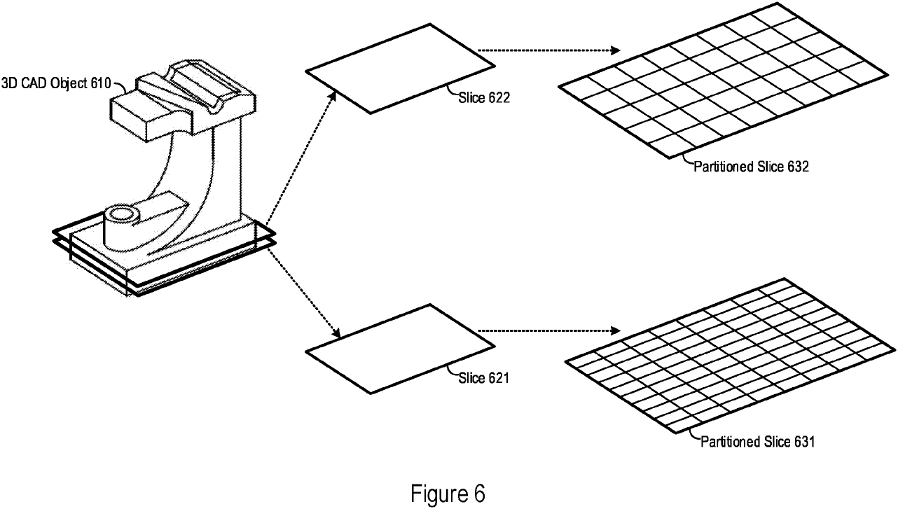

While some examples of heat-aware criteria features are described above, any parameter or criteria that accounts for heat deformation in the 3D printing of physical parts is contemplated herein to set as part of heat-aware criteria. Moreover, while many of the examples presented above are provided in the context of a single layer, any of the various heat-aware toolpath features described herein may be applied in combination, for example for different slices of a 3D CAD combination. Some examples of such are described next in connection with FIG. 6.

FIG. 6 shows an example application of different heat-aware criteria for different portions of a 3D CAD object. In FIG. 6, multiple slices from a 3D CAD object 610 may be accessed (e.g., by the access engine 108) and different heat-aware criteria may be applied to the different slices. In particular, the heat-aware toolpath engine 110 may generate heat-aware layer toolpaths differently for the slices 621 and 622 of the 3D CAD object 610 shown in FIG. 6.

In some implementations, the heat-aware toolpath engine 110 may apply different partitioning parameters for the slices 621 and 622 (and the partitioning parameters may be embedded as part of heat-aware criteria). The partitioning parameters may vary based on the position of the slices 621 and 622 in the 3D CAD object 610 respectively. For instance, the physical layer represented by slice 621 may be scheduled for 3D printing prior to the physical layer represented by the slice 622. This may be the case as the slice 622 is at a higher position along a build-axis than slice 621, and thus slice 622 may be 3D printed on top of slice 621 (whether directly or indirectly). This may also mean that the physical layer represented by the since 621 may be closer to the build plate than the physical layer represented by the slice 622, and thus slice 621 may be more susceptible to heat that has accumulated or is emanating from the build plate.

To account for increased heat sensitivity or heat exposure for the slice 621 (as compared to the slice 622), the heat-aware toolpath engine 110 may partition the slice 621 at a finer granularity (e.g., zone area) than the slice 622. An example of such a difference in partitioning granularity is illustrated in FIG. 6 through the partitioned slice 632 partitioned by the heat-aware toolpath engine 110 from the slice 622 at a coarser granularity than the partitioned slice 631 partitioned from the slice 621.

By partitioning a slice with (relatively) smaller zone sizes and selecting a non-continuous zone order according to applied heat-aware criteria, the heat-aware toolpath engine 110 may ensure that 3D printing of a given layer section will complete sooner (as compared to zone orders with larger zone sizes). In that regard, a heat-aware toolpath generated by the heat-aware toolpath engine 110 for the partitioned slice 631 may route the 3D printing to a different layer section of the represented physical layer in a shorter time as compared to a heat-aware toolpath generated for the partitioned slice 632 with larger zone sizes. In such a way, the heat-aware toolpath engine 110 may account for increased heat exposures for physical layers within a threshold distance from a build plate or other heat-emitting portion of a 3D printing system.

Additionally or alternatively, by partitioning the slice 622 at a coarser granularity that the slice 621, the heat-aware toolpath engine 110 may take advantage of the reduced heat sensitivity or heat exposure for physical layers that a further distance from a build plate (e.g., beyond a predetermined or threshold distance). By partitioning the slice 622 with larger zone sizes (as compared to the partitioned slice 631 partitioned from the slice 621), the heat-aware toolpath engine 110 may increase 3D printing efficiency by reducing the number of zones in a determined zone order, increasing the continuity of the 3D printing toolpath, or decreasing the total distance of a generated layer toolpath (and thus reducing 3D printing time). As such, the heat-aware toolpath engine 110 may flexibly account for slice characteristics in partitioning of different slices of a 3D CAD object, including by partitioning a slice into zones that are greater in area than zones of a different slice that represents another physical layer that is to be manufactured prior to the physical layer in the 3D printing of a physical part.

As another feature for different slices, the heat-aware toolpath engine 110 may vary the heat-aware criteria applied to various slices of a 3D CAD object. For instance, the heat-aware toolpath engine 110 may rotate, in a round-robin fashion, amongst a set of heat-aware criteria for application to slices of a 3D CAD object. In that regard, the heat-aware toolpath engine 110 may apply a max-distance heat-aware criterion for determining a zone order for the partitioned slice 631, apply a threshold-distance heat-aware criterion for the partitioned slice 632, and continue to rotate among various heat-aware criteria to apply for other slices of the 3D CAD object 610. As such, the heat-aware toolpath engine 110 may apply different heat-aware criteria for generating layer toolpaths of different slices of a 3D CAD object.

Additionally or alternatively, the heat-aware toolpath engine 110 may apply multiple different heat-aware criteria for a single slice, e.g., by further dividing zones of partitioned slice into sub-partitions and applying a different heat-aware criterion to each sub-partition. As yet another feature, the heat-aware toolpath engine 110 may apply a heat-aware criterion for only a selected portion of a 3D CAD object slice. For instance, the heat-aware toolpath engine 110 may identify a portion of a slice to apply heat-aware criteria to based on finite element analyses or other manufacturing simulations that can indicate 3D part hotspots that will be deformed during 3D printing. The heat-aware toolpath engine 110 may specifically partition these identified sub-sections (e.g., hotspots) of a slice and apply heat-aware criteria to generate a heat-aware toolpath specific to the identified slice portion. For the remaining portion of the slice (e.g., non-hotspots), the heat-aware toolpath engine 110 may apply other toolpath generation techniques, e.g., as a continuous line scan toolpath or to otherwise optimize 3D printing efficiency without the heat-aware toolpath features described herein.

While many heat-aware toolpath features have been described herein through illustrative examples presented through various figures, the access engine 108 and the heat-aware toolpath engine 110 may implement any combination of the heat-aware toolpath features described herein.

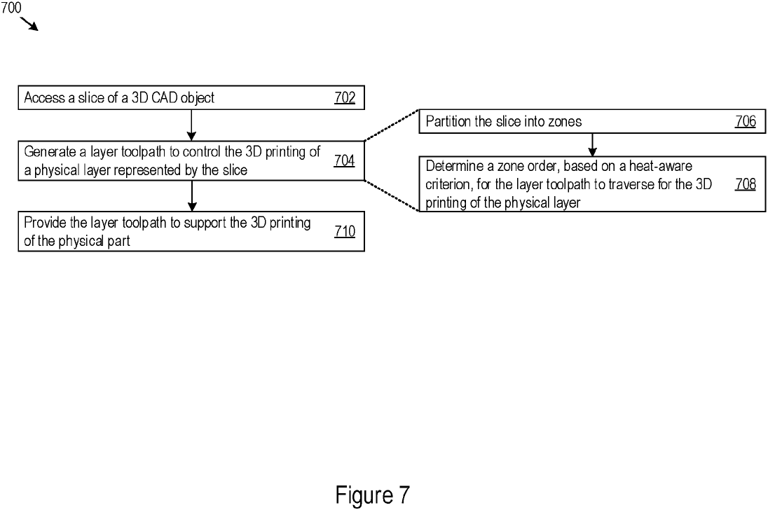

FIG. 7 shows an example of logic 700 that a system may implement to support generation of heat-aware toolpaths for 3D printing of physical parts. For example, the computing system 100 may implement the logic 700 as hardware, executable instructions stored on a machine-readable medium, or as a combination of both. The computing system 100 may implement the logic 700 via the access engine 108 and the heat-aware toolpath engine 110, through which the computing system 100 may perform or execute the logic 700 as a method to support generation of heat-aware toolpaths for 3D printing of physical parts. The following description of the logic 700 is provided using the access engine 108 and the heat-aware toolpath engine 110 as examples. However, various other implementation options by systems are possible.

In implementing the logic 700, the access engine 108 may access a 3D CAD object (702). The 3D CAD object may represents a physical part and the slice may represent a physical layer for 3D printing of the physical part. In implementing the logic 700, the heat-aware toolpath engine 110 may generate a layer toolpath to control the 3D printing of the physical layer represented by the slice (704), including by partitioning the slice into zones (706) and determining a zone order, based on a heat-aware criterion, for the layer toolpath to traverse for the 3D printing of the physical layer (708). The heat-aware toolpath engine 110 may do so in any of the ways described herein. In implementing the logic 700, the heat-aware toolpath engine 110 may also provide the layer toolpath to support the 3D printing of the physical part (710).

The logic 700 shown in FIG. 7 provides an illustrative example by which a computing system 100 may support generation of heat-aware toolpaths for 3D printing of physical parts. Additional or alternative steps in the logic 700 are contemplated herein, including according to any of the various features described herein for the access engine 108, the heat-aware toolpath engine 110, or any combinations thereof.

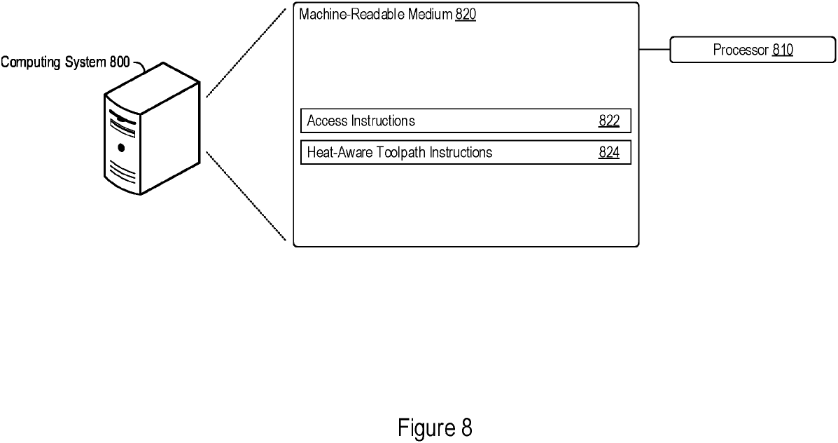

FIG. 8 shows an example of a computing system 800 that supports generation of heat-aware toolpaths for 3D printing of physical parts. The computing system 800 may include a processor 810, which may take the form of a single or multiple processors. The processor(s) 810 may include a central processing unit (CPU), microprocessor, or any hardware device suitable for executing instructions stored on a machine-readable medium. The system 800 may include a machine-readable medium 820. The machine-readable medium 820 may take the form of any non-transitory electronic, magnetic, optical, or other physical storage device that stores executable instructions, such as the access instructions 822 and the heat-aware toolpath instructions 824 shown in FIG. 8. As such, the machine-readable medium 820 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 800 may execute instructions stored on the machine-readable medium 820 through the processor 810. Executing the instructions (e.g., the access instructions 822 and/or the heat-aware toolpath instructions) may cause the computing system 800 to perform any of the described herein, including according to any of the features of the access engine 108, the heat-aware toolpath engine 110, or combinations of both.

For example, execution of the access instructions 822 by the processor 810 may cause the computing system 800 to access a slice of a 3D CAD object. The 3D CAD object may represent a physical part and the slice may represent a physical layer for 3D printing of the physical part. Execution of the heat-aware toolpath instructions 824 by the processor 810 may cause the computing system 800 to generate a layer toolpath to control the 3D printing of the physical layer, including by partitioning the slice into zones and determining a zone order, based on a heat-aware criterion, for the layer toolpath to traverse for the 3D printing of the physical layer. Execution of the heat-aware toolpath instructions 824 by the processor 810 may cause the computing system 800 to provide the layer toolpath to support the 3D printing of the physical part.

Any additional or alternative heat-aware toolpath features as described herein may be implemented via the access instructions 822, heat-aware toolpath instructions 824, or a combination of both.

The systems, methods, devices, and logic described above, including the access engine 108 and the heat-aware toolpath engine 110, may be implemented in many different ways in many different combinations of hardware, logic, circuitry, and executable instructions stored on a machine-readable medium. For example, the access engine 108, the heat-aware toolpath engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the access engine 108, the heat-aware toolpath engine 110, or combinations thereof.

The processing capability of the systems, devices, and engines described herein, including the access engine 108 and the heat-aware toolpath engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
accessing a slice of a 3-dimensional (3D) computer-aided design (CAD) object, wherein the 3D CAD object represents a physical part and wherein the slice represents a physical layer for 3D printing of the physical part;
generating a layer toolpath to control the 3D printing of the physical layer, including by:
partitioning the slice (230) into zones; and
determining a zone order, based on a heat-aware criterion, for the layer toolpath to traverse for the 3D printing of the physical layer; and
providing the layer toolpath to support the 3D printing of the physical part.

2. The method of claim 1, wherein the heat-aware criterion specifies selection of a subsequent zone in the zone order that is a maximum distance from a current zone.

3. The method of claim 1, wherein the heat-aware criterion specifies selection of a subsequent zone in the zone order that is a predetermined distance from a current zone.

4. The method of claim 1, wherein the heat-aware criterion specifies selection of a subsequent zone in the zone order that is adjacent to a current zone and wherein generating the layer toolpath further comprises reversing a starting point and ending point of the toolpath for the 3D printing of the subsequent zone.

5. The method of claim 1, comprising applying a different heat-aware criterion for generating a layer toolpath of a different slice of the 3D CAD object.

6. The method of claim 1, comprising partitioning the slice into zones that are greater in area than zones of a different slice that represents another physical layer that is to be manufactured prior to the physical layer in the 3D printing of the physical part.

7. The method of claim 1, wherein the heat-aware criterion specifies determination of a starting zone in the zone order that is at least a threshold distance from an ending zone of a zone order determined for a different slice, wherein the different slice represents another physical layer that is to be manufactured prior to the physical layer in the 3D printing of the physical part.

8. A system comprising:
an access engine configured to access a slice of a 3-dimensional (3D) computer-aided design (CAD) object, wherein the 3D CAD object represents a physical part and wherein the slice represents a physical layer for 3D printing of the physical part;
a heat-aware toolpath engine configured to:
generate a layer toolpath to control the 3D printing of the physical layer, including by:
partitioning the slice into zones; and
determining a zone order, based on a heat-aware criterion, for the layer toolpath to traverse for the 3D printing of the physical layer; and
provide the layer toolpath to support the 3D printing of the physical part.

9. The system of claim 8, wherein the heat-aware criterion specifies selection of a subsequent zone in the zone order that is a maximum distance from a current zone.

10. The system of claim 8, wherein the heat-aware criterion specifies selection of a subsequent zone in the zone order that is a predetermined distance from a current zone.

11. The system of claim 8, wherein the heat-aware criterion specifies selection of a subsequent zone in the zone order that is adjacent to a current zone and wherein the heat-aware toolpath engine is configured to generate the layer toolpath further by reversing a starting point and ending point of the toolpath for the 3D printing of the subsequent zone.

12. The system of claim 8, wherein the heat-aware toolpath engine is configured to apply a different heat-aware criterion for generating the layer toolpath of a different slice of the 3D CAD object.

13. The system of claim 8, wherein the heat-aware toolpath engine is configured to partition the slice into zones that are greater in area than zones of a different slice that represents another physical layer that is to be manufactured prior to the physical layer in the 3D printing of the physical part.

14. The system of claim 8, wherein the heat-aware criterion specifies determination of a starting zone in the zone order that is at least a threshold distance from an ending zone of a zone order determined for a different slice, wherein the different slice represents another physical layer that is to be manufactured prior to the physical layer in the 3D printing of the physical part.

15. A non-transitory machine-readable medium comprising instructions that, when executed by a processor, cause a computing system to:
access a slice of a 3-dimensional (3D) computer-aided design (CAD) object, wherein the 3D CAD object represents a physical part and wherein the slice represents a physical layer for 3D printing of the physical part;
generate a layer toolpath to control the 3D printing of the physical layer, including by:
partitioning the slice into zones; and
determining a zone order, based on a heat-aware criterion, for the layer toolpath to traverse for the 3D printing of the physical layer; and
provide the layer toolpath to support the 3D printing of the physical part.

16. The non-transitory machine-readable medium of claim 15, wherein the heat-aware criterion specifies selection of a subsequent zone in the zone order that is a predetermined distance from a current zone.

17. The non-transitory machine-readable medium of claim 15, wherein the heat-aware criterion specifies selection of a subsequent zone in the zone order that is adjacent to a current zone and wherein the instructions cause the computing system to generate the layer toolpath further by reversing a starting point and ending point of the toolpath for the 3D printing of the subsequent zone.

18. The non-transitory machine-readable medium of claim 15, wherein the instructions cause the computing system to apply a different heat-aware criterion for generating the layer toolpath of a different slice of the 3D CAD object.

19. The non-transitory machine-readable medium of claim 15, wherein the instructions cause the computing system to partition the slice into zones that are greater in area than zones of a different slice that represents another physical layer that is to be manufactured prior to the physical layer in the 3D printing of the physical part.

20. The non-transitory machine-readable medium of claim 15, wherein the heat-aware criterion specifies determination of a starting zone in the zone order that is at least a threshold distance from an ending zone of a zone order determined for a different slice, wherein the different slice represents another physical layer that is to be manufactured prior to the physical layer in the 3D printing of the physical part.
